(19) United States
(12) Patent Application Publication
(10) Pub. No.: US 2026/0103279 A1
(43) Pub. Date: Apr. 16, 2026

(54) METHOD FOR CONTROLLING AIRCRAFT AND AIRCRAFT SYSTEM

(71) Applicant: Jianjun MI, Qingdao (CN)

(72) Inventor: Jianjun MI, Qingdao (CN)

(21) Appl. No.: 19/232,919

(22) Filed: Jun. 10, 2025

Related U.S. Application Data
(63) Continuation of application No. PCT/CN2023/125823, filed on Oct. 23, 2023.

(30) Foreign Application Priority Data
Dec. 14, 2022 (CN) 202211586014.7

(51) Int. Cl. B64C 19/00; A63C 17/12; A63C 17/26; B64C 17/00; B64C 25/32; B64C 25/36; B64C 25/64; B64C 39/02; B64D 47/00

(52) U.S. Cl. CPC B64C 19/00; A63C 17/12; A63C 17/267; B64C 17/00; B64C 25/405; B64C 39/026; B64D 47/00

(57) ABSTRACT

The present application aims to provide an aircraft control method and an aircraft system, which can simplify the control of an aircraft combination having a pedal moving device arranged at the foot, so that it is easier for a person to carry the aircraft to walk, take off and land, the aircraft is easy to control, and the coordination problem of portions is solved. The aircraft control method comprises the following steps: an aircraft is fixedly connected to a person, and is supported by the feet of the person on the ground; a pedal moving device is provided for the feet of the person, and can carry the person and the aircraft to move on the ground; an operation-state information transmission device is provided between the aircraft and the pedal moving device; and the control of the pedal moving device is associated with the control of the aircraft by means of the information transmission device. The aircraft system, comprising an aircraft body and a pedal moving device, wherein the aircraft body is fixedly connected to a person, and is supported by the feet of the person on the ground, and the pedal moving device is provided for the feet of the person.

### CROSS-REFERENCE TO THE RELATED APPLICATIONS

This application is a Continuation of International Application No. PCT/CN2023/125823, filed on Oct. 23, 2023, which is based upon and claims priority to Chinese Patent Application No. 202211586014.7, filed on Dec. 14, 2022, the entire contents of which are incorporated herein by reference.

### TECHNICAL FIELD

The present application relates to the field of aircraft, and in particular, to an aircraft control method and an aircraft system.

### BACKGROUND ART

Existing various aircraft make our transportation more and more convenient. There is a type of single-person aircraft, which is mainly characterized by being used by one person and carried on the human body. When on the ground, it is supported by the human legs and driven to fly by means of a turbojet or an electric motor propeller, etc. In order to facilitate movement and takeoff and landing, pedal moving devices such as human-powered roller skates or electric roller skates are provided on the human feet. The pedal moving devices on the feet help the human body carry and bear the aircraft to move, as well as take off and land, which has a good effect. However, the takeoff and landing of the aircraft need to be controlled by the human body, such as controlling the driving force of the power device of the aircraft, controlling the attitude control device of the aircraft to adjust the attitude of the aircraft, etc. The pedal moving devices provided on the feet also need some control by the human body. These aircraft have a large weight relative to the human body. It is very difficult to control when carrying such a heavy weight and needing to carry out control operations in multiple directions. Once control operations are incorrect, serious consequences will occur. For example, if the aircraft accelerates too fast and the pedal moving device under the feet runs too slowly, the human body will fall forward under the load. On the contrary, the human body will fall backward. The aircraft is provided with a power source, a propeller, an internal combustion engine, etc., which will cause great harm to the life safety of the aircraft user or surrounding personnel, cause property losses, and affect the use and development of such aircraft, which needs to be improved.

### SUMMARY OF THE INVENTION

### Technical Problem

Enter the descriptive paragraph of the technical issue here.

### Technical Solution

The purpose of the present application is to provide an aircraft control method and an aircraft system, which can simplify the control of an aircraft system with a pedal moving device arranged on the feet, make it easier for the human body to carry the aircraft to walk, take off and land, make the aircraft easy to control, and solve the coordination problem of each part.

To achieve the above purpose, the present application is realized through the following technical solutions: An aircraft control method, in which the aircraft is fixedly connected to the human body, the aircraft is supported on the ground by the feet of the human body, the feet of the human body are provided with pedal moving devices, and the pedal moving devices can carry the human body and the aircraft to move on the ground. The control method is that an operation-state information transmission device is arranged between the aircraft and the pedal moving device, and the control of the pedal moving device is associated with the control of the aircraft through the information transmission device.

In the aircraft control method, the control of the pedal moving device is associated with the control of the aircraft. The association method is that the aircraft controls its operation according to the operation state of the pedal moving device. For example, when the human body uses the aircraft and the pedal moving device to run on the ground, the aircraft runs in the air according to the operation state of the pedal moving device, so that the human body can coordinate the force and posture between the pedal moving device and the aircraft and reduce risks. Or the pedal moving device controls its operation according to the operation state of the aircraft. For example, when the human body uses the aircraft and the pedal moving device to land from the air, the pedal moving device controls its operation according to the state information of the aircraft to adapt to the state of the human body and the aircraft before landing. For example, before landing on the ground, the pedal moving device starts to operate at the same speed as the aircraft, so that the human body will not fall forward due to the resistance generated by the unstarted pedal moving device when landing on the ground.

In the aircraft control method, the control of the pedal moving device is associated with the control of the aircraft. The association is that after the human body and the aircraft leave the ground, the pedal moving device stops running, the association between the control of the aircraft and the control of the pedal moving device is canceled, and the aircraft is controlled to fly by the human body. For example, the human body uses a control handle to control the flight attitude and power. Many similar existing technologies are not described here. When the aircraft leaves the ground, the control can be switched by a manual switch, and the association between the aircraft and the pedal moving device can be cut off. For example, a toggle switch is arranged on the aircraft handle. Or a ground separation sensor is arranged on the pedal moving device. The ground separation sensor such as a pressure sensor, a distance sensor, etc., detects that the pedal moving device leaves the ground and automatically switches. The aircraft is controlled to fly in the air by the human body. For example, a single-chip microcomputer or an integrated circuit is responsible for switching according to a preset program and a preset value. Specifically, those skilled in the art can set it according to the actual conditions such as the performance and power of different models of aircraft and pedal moving devices, which is not described here.

In the aircraft control method, the aircraft is provided with a flight power device and an attitude control device, the pedal moving device is provided with a pedal power device. When the human body and the aircraft are on the ground, the output power of the pedal power device of the pedal moving device is in a positive proportional relationship with the output power of the flight power device of the aircraft, and/or the attitude control device of the aircraft adjusts the attitude according to the operation of the pedal moving device. It includes at least one of the following settings: the output power of the pedal power device of the pedal moving device changes in direct proportion to the output power of the flight power device of the aircraft, and the output power of the flight power device of the aircraft changes in direct proportion to the output power of the pedal power device of the pedal moving device.

An aircraft system includes an aircraft body and a pedal moving device. The aircraft body is fixedly connected to the human body, the aircraft body is supported on the ground by the feet of the human body, and the feet of the human body are provided with pedal moving devices. The aircraft system is characterized in that an information transmission device is further arranged between the pedal moving device and the aircraft body. The information transmission device is provided with a detection device, and the detection device is used for detecting the operation state of the pedal moving device or/and the operation state of the aircraft body and transmitting data between the aircraft body and the pedal moving device for the control of the pedal moving device and the aircraft body.

An aircraft system, the aircraft body is provided with a flight power device, an attitude control device, an aircraft power supply and a flight controller. The flight controller is powered by the aircraft power supply and controls the operation of the flight power device and the attitude control device. The flight controller is connected to the detection device by wired or wireless means and controls the power output of the flight power device and/or controls the attitude control device according to the output data of the detection device.

The flight power device can be a motor-driven propeller, a turbojet engine and other related devices. The attitude control device can be a main wing, an aileron, a tail rudder, a steering engine and other related devices of the aircraft. The detection device includes at least one of a speed detection device and a power detection device, and each part can be used in combination with each other.

The aircraft body is fixed on the back of the human body through a fixing part. A shock-absorbing and buffering device is arranged between the fixing part and the human body. The aircraft body is provided with leg brackets, which extend downward from the part where the fixing part of the aircraft body is fixed to the human body. The lower end of the leg bracket is connected to the foot of the human body or the pedal moving device. The leg bracket has elasticity. The connection between the leg bracket and the human leg is such that the leg bracket has a tendency to bend along the bending direction of the human leg before being subjected to the pressure between the human foot and the aircraft body, and can bend in the bending direction of the human leg when subjected to the pressure between the human foot and the aircraft body. The lower end of the leg bracket is connected to the human foot or the pedal moving device. The connection position can be at the front, back or side of the human foot, and can be fixedly connected by using the elasticity of the leg bracket. Or, a movable joint such as a shaft sleeve, a fish-eye joint bearing, a universal joint or a ball joint is arranged at the connection position to realize a movable bending connection with the pedal moving device, so that the operation of the pedal moving device is not limited by the leg bracket. When the human body uses the aircraft combination, the leg bracket has a multi-faceted supporting role. When the human body and the aircraft combination stand vertically, the leg bracket transmits the weight of the human body and the aircraft body to the pedal moving device to reduce the burden on the human body. When the human body and the aircraft combination fly horizontally, the leg bracket uses its own elasticity to support the human legs to prevent the human legs from bending downward due to weight and reduce the burden on the human legs. A horizontal tail and/or a vertical tail are/is arranged on the leg bracket, and the horizontal tail and/or the vertical tail on the leg brackets of the left and right legs of the human body are respectively arranged. The movement of the human legs drives the horizontal tail and the vertical tail to change their attitudes.

The aircraft body is also provided with a head bracket upwards, and the head bracket is directly or indirectly connected to the human head. The head bracket has elasticity, or/and the connection position between the bracket and the head is a movable connection, so that the head can swing and rotate. The head bracket is set not only to protect the head by means of a helmet, etc., but also to have a supporting force on the head because the head bracket is connected between the aircraft body and the helmet or the head. The supporting force includes an axial force and a radial force from the aircraft body to the head direction. When the human body and the aircraft body stand or fly in the vertical direction, the human head is fixed to the helmet, and the axial supporting force of the head bracket reduces the burden on the human head.

When the human body and the aircraft body fly horizontally, the radial supporting force reduces the burden of the human head on the human neck. When the human body and the aircraft body run obliquely, both the axial and radial supporting forces play a role in reducing the burden on the human body, avoiding excessive load on the human neck, and being beneficial to the control of the aircraft body by the human body.

The pedal moving device is a human-powered roller skate, which runs by human pedaling. The human-powered roller skates are respectively fixed under the left and right feet of the human body, and the human-powered roller skates under the left and right feet can run forward alternately. The human-powered roller skates are provided with pulleys and a speed sensor, and the speed sensor detects the running speed and/or acceleration of the pulleys. The speed sensor is connected to the flight controller by a cable or a wireless transceiver between the aircraft body and the human-powered roller skates, and transmits the speed information of the human-powered roller skates to the flight controller. When the human body drives the human-powered roller skates on the left and right feet to leave the ground, the human-powered roller skates lose power, and the pulleys stop rotating. The speed sensor detects that the speed is less than a set value or zero, and transmits information to the flight controller of the aircraft body to switch the control of the aircraft body. The speed sensor and the cable or the wireless transceiver form an information transmission device, and the speed sensor, as a detection device, has both the functions of detecting the running state of the human-powered roller skates and detecting the ground separation. Or the speed sensor detects the speed of the human-powered roller skates relative to the ground, is connected to the flight controller by a cable or a wireless transceiver between the aircraft body and the human-powered roller skates, and transmits the speed information of the human-powered roller skates to the flight controller. When the human-powered roller skates leave the ground, the speed sensor detects that the speed value is less than a set value or zero, and transmits information to the flight controller of the aircraft body to switch the control of the aircraft body. There are many types of speed sensors, and how to realize the detection of speed can be set by those skilled in the art according to the actual situation, which is not described here. The wireless transceiver is also a technology that can be realized by the prior art for information transmission, which is not described here. The pulleys can also be replaced by tracks, or the pulleys and tracks can be used in combination.

The pedal moving device is an electric roller skate, which is provided with an electric roller pulley, a roller skate controller and a roller skate power supply. The electric roller skates are respectively fixed under the left and right feet of the human body, and the electric roller skates under the left and right feet can run forward alternately. The electric roller pulley is a wheel type or a track type, and the roller skate controller controls the operation of the electric roller pulley by means of the power supply of the roller skate. The electric roller skate is also provided with a first ground separation sensor and a first human body attitude sensor, which are connected to the roller skate controller. The first ground separation sensor is used for detecting whether the electric roller skate is in a ground separation state or a ground connection state, and the first human body attitude sensor is used for detecting the forward or backward tilting attitude of the human body. The roller skate controller controls the electric roller pulley to operate when both feet are on the ground according to the information of the first ground separation sensor, controls the electric roller pulleys on the ground and the ground separation to operate at the same speed when one foot is on the ground, and controls the electric roller pulley to stop operating when both feet are off the ground. The roller skate controller controls the electric roller skate to accelerate when the human body tilts forward and decelerate or move backward when the human body tilts backward according to the information of the first human body attitude sensor. At least one of the first ground separation sensor, the first human body attitude sensor and the roller skate controller is connected to the flight controller and transmits the signal of the electric roller skate to the flight controller. The roller skate power supply independently supplies power to the roller skate controller or shares the power supply with the aircraft body.

The pedal moving device is an electric balance car, which is respectively arranged under the left and right feet of the human body, and the electric balance cars under the left and right feet can run forward alternately. The electric balance car is also provided with an electric balance wheel, a balance controller and a balance car power supply. The balance controller controls the operation of the electric balance wheel and the balance of the electric balance car by means of the power supply of the balance car. A second ground separation sensor and a second human body attitude sensor are arranged in the electric balance car, which are connected to the balance controller. The second ground separation sensor is used for detecting whether the electric balance car is in a ground separation state or a ground connection state, and the second human body attitude sensor is used for detecting the forward or backward tilting attitude of the human body. The balance controller controls the electric balance wheel to operate when both feet are on the ground according to the information of the second ground separation sensor, controls the electric balance wheels on the ground and the ground separation to operate at the same speed when one foot is on the ground, and controls the electric balance wheel to stop operating when both feet are off the ground. The balance controller controls the electric balance car to accelerate when the human body tilts forward and decelerate or move backward when the human body tilts backward according to the information of the second human body attitude sensor to maintain the balance of the human body. At least one of the second ground separation sensor, the second human body attitude sensor and the balance controller is connected to the flight controller and transmits the signal of the electric balance car to the flight controller. The balance car power supply independently supplies power to the balance controller or shares the power supply with the aircraft body. When the electric balance car is used, the electric balance wheel is arranged in the middle of the front and rear directions of the electric balance car. The electric balance wheel is a single wheel or multiple wheels arranged transversely along the forward and backward directions of the electric balance car, which is beneficial to balance. The lower end of the leg bracket is connected to the middle position of the front and rear directions of the side of the electric balance car.

According to the above aircraft control method and aircraft system, when the pedal moving devices such as the human-powered roller skates, the electric roller skates and the electric balance car accelerate on the ground, the aircraft body also accelerates, increases power output and adjusts the attitude to match the acceleration of the pedal moving device. When the pedal moving device decelerates, the aircraft body also decelerates, reduces power output and adjusts the attitude to match the deceleration of the pedal moving device. When the pedal moving device moves backward, the aircraft body also moves backward, and the power output and attitude are adjusted in the reverse direction, such as the reverse rotation of the propeller, etc. When the pedal moving device leaves the ground, the flight controller controls the flight according to the human body. The existing technology for the control of the aircraft body is not described here, and those skilled in the art can understand and set it according to the specific structure and principle of different aircraft bodies.

In fact, from the knowledge of physical electricity, power can be calculated by the product of voltage and current. When the voltage is constant, the magnitude of power is in a positive proportional relationship with the magnitude of current. Therefore, the power detection information can be obtained by detecting the current.

The beneficial effects of the present application are as follows: By adopting the aircraft control method and device of the present application, the method and device for associating between the aircraft and the pedal moving device can make the aircraft body part and the pedal moving device part of the aircraft system run in coordination with each other when the human body uses the aircraft system of the present application, prevent human injury and property loss caused by the inconsistent operation of the aircraft body part and the pedal moving device part of the aircraft system during the ground operation, and improve the operation efficiency of the aircraft system. The aircraft system of the present application also adopts a human body fixing device with a shock-absorbing and buffering function and the leg bracket to reduce the burden on the human body, and adopts a head bracket to reduce the burden on the human head. The leg bracket and the head bracket not only function when the human body uses the aircraft system to run on the ground, but also can reduce the burden on the human body when the human body uses the aircraft system to fly in the air, so that the human body can maintain a posture suitable for flight without too much force and fatigue. By adopting the electric roller skates and the electric unicycle balance car of the present application, the coordinated movement during the □ □ (leaving the ground) and □□ (grounding) of the human feet can be controlled. Through the above settings of the present application, the aircraft system of the present application is more suitable for human use, reduces risks, and is more stable. The human body controls the operation of the pedal moving device with the feet, and the pedal moving device is associated with the control of the aircraft body. Therefore, when the aircraft system of the present application runs as a whole, the human body does not need to control the aircraft body separately, but only needs to control the pedal moving device with the feet to achieve the purpose of synchronously controlling the aircraft, realize the unity of the whole device, greatly simplify the control process, and be able to adapt to the repeated, flexible and safe takeoff and landing of the human body and the aircraft.

### Beneficial Effects

Type the descriptive paragraph of beneficial effects here.

### BRIEF DESCRIPTION OF THE DRAWINGS

FIG. 1 is a schematic side view of an aircraft system with human-powered roller skates or electric roller skates according to the present application;

FIG. 2 is a schematic front view of the use of an aircraft system with human-powered roller skates or electric roller skates by a human body according to the present application;

FIG. 3 is a schematic side view of an aircraft system with an electric balance car according to the present application;

FIG. 4 is a schematic side view of the connection between the electric balance car and the leg bracket according to the present application;

FIG. 5 is a schematic side view of a connection between the head bracket and a helmet according to the present application;

FIG. 6 is a schematic side view of the connection between the human-powered roller skates or electric roller skates and the leg bracket according to the present application;

FIG. 7 is a schematic view of a connection structure of a connection end of the leg bracket according to the present application;

FIG. 8 is a schematic view of a connection structure of a horizontal tail and a vertical tail with the leg bracket according to the present application;

FIG. 9 is a schematic view of another connection structure of the connection end of the leg bracket according to the present application;

FIG. 10 is a schematic partial view of another connection structure of the connection end of the leg bracket according to the present application;

In the figures: 1—aircraft body, 2—fixing part, 3—head bracket, 31—inner hole of head bracket, 32—outer hole of head bracket, 33—head bracket stop cap, 34—stop cap bottom plate, 35—stop cap spring, 4—helmet, 41—first connection end of helmet, 42—second connection end of helmet, 5—leg bracket, 6—linear Hall device, 61—second rotating shaft, 62—pin, 63—permanent magnet, 64—second shaft sleeve, 7—human-powered roller skates or electric roller skates, 71—speed sensor, 8—electric balance car, 81—electric balance wheel, 9—connection end of leg bracket, 91—inner hole, 92—washer, 93—first shaft sleeve, 94—pin hole, 95—first rotating shaft, 96—through hole, 97—signal line, 98—base, 99—knob, 10—horizontal tail, 11—vertical tail, 12—foot fixing strap.

### EMBODIMENTS

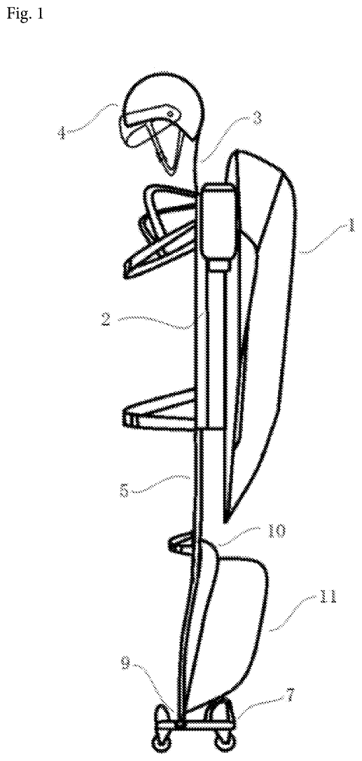

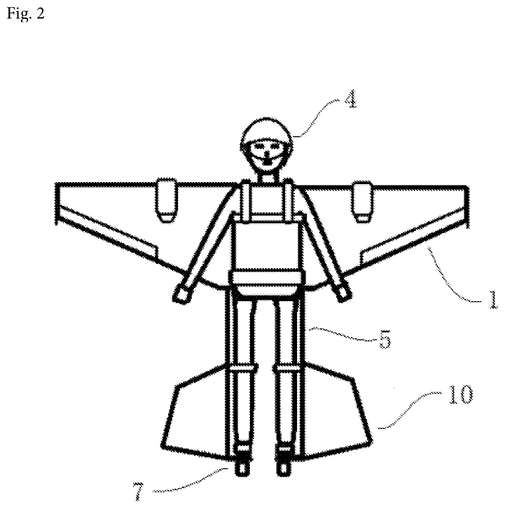

The present application will be further described below in conjunction with specific embodiments. FIG. 1 is a schematic side view of an aircraft system with human-powered roller skates or electric roller skates according to the present application; as can be seen in conjunction with FIG. 2, the aircraft body 1 in the figure is connected to the back of the human body through a fixing part 2. The fixing part 2 fixes the human body through chest and waist fixing straps, the bracket 5 fixes the human body through leg fixing straps, and the foot fixing straps fix the human feet to the pedal moving device, i.e., the human-powered roller skates or electric roller skates 7. A damping and shock-absorbing system is arranged between the fixing part 2 and the human body, so that the human body and the aircraft body 1 can move relative to each other within a certain distance range, and the impact of the aircraft body 1 on the human body can be reduced when the human body moves with the aircraft body 1. For example, when the human body moves on the ground, the impact of up-and-down vibration on the human body can be reduced, the impact force of the aircraft body on the human body can be reduced, the human body can carry the aircraft body easily, physical energy consumption can be reduced, and the moving speed can be faster. There are many types of specific damping and shock-absorbing system designs, which can be realized by those skilled in the art according to the prior art and are not described here. For example, the device described in the application number CN2021212657645 (invention name: a backpack aircraft); the aircraft body 1 is provided with a head bracket 3 upwards, and the head bracket 3 has at least one of axial and radial elasticity. For example, the head bracket is made of elastic steel or composite materials such as carbon fiber, which can bend in at least one direction of the up-down axial direction or the left-right radial direction. The lower end of the head bracket 3 is fixedly connected to the aircraft body 1, and the upper end of the head bracket 3 can be movably connected to the human head directly or indirectly. The direct connection is, for example, directly fixing to the head with a strap, and the indirect connection is, for example, the upper end of the head bracket 3 is movably connected to the helmet 4 in this embodiment. The aircraft body 1 is provided with leg brackets 5 downwards, and the lower ends of the leg brackets are connected to the human-powered roller skates or electric roller skates 7.

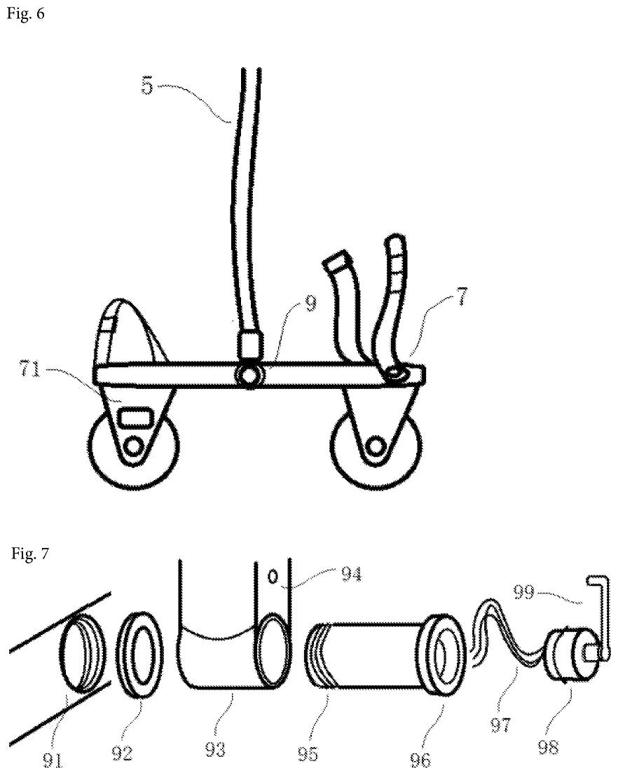

When human-powered roller skates are used, the human-powered roller skates run by human pedaling. For example, the human body drives the human-powered roller skates with both feet to pedal the ground in an outward (□□) shape in turn. The human-powered roller skates are respectively fixed under the left and right feet of the human body, and the human-powered roller skates under the left and right feet can run forward alternately. The human-powered roller skates are provided with pulleys and a speed sensor, and the speed sensor detects the running speed and/or acceleration of the pulleys. The speed sensor is connected to the flight controller of the aircraft body 1 by a wired or wireless way, and transmits the speed information of the human-powered roller skates to the flight controller. The pulleys can also be replaced by tracks, or the pulleys and tracks can be used in combination. The speed sensor has many applications in the prior art and is widely used in transportation vehicles such as various automobiles and aircraft, as well as industrial machine tools and agricultural equipment. For example, the speed sensor 71 in FIG. 6 is arranged near the pulley to detect the rotation speed, and the gyroscope is fixed on the human-powered roller skates to detect the acceleration, which is the prior art. Those skilled in the art can set and implement it according to the content of the present application and the actual situation, which is not described here.

When electric roller skates are used, the electric roller skates are provided with an electric roller pulley, a roller skate controller and a roller skate power supply. The electric roller skates are respectively fixed under the left and right feet of the human body, and the electric roller skates under the left and right feet can run forward alternately. The electric roller pulley is a wheel type or a track type, and the roller skate controller controls the operation of the electric roller pulley by means of the roller skate power supply. A first ground separation sensor and a first human body attitude sensor are also arranged in the electric roller skates, which are connected to the roller skate controller. The first ground separation sensor is used for detecting whether the electric roller skates are in a ground separation state or a ground connection state, and the first human body attitude sensor is used for detecting the forward or backward tilting attitude of the human body. The roller skate controller controls the electric roller pulley to operate when both feet are on the ground according to the information of the first ground separation sensor, controls the electric roller pulleys on the ground and the ground separation to operate at the same speed when one foot is on the ground, and controls the electric roller pulley to stop operating when both feet are off the ground. The roller skate controller controls the electric roller skates to accelerate when the human body tilts forward and decelerate or move backward when the human body tilts backward according to the information of the first human body attitude sensor. At least one of the first ground separation sensor, the first human body attitude sensor and the roller skate controller is connected to the flight controller of the aircraft body 1 and transmits the signal of the electric roller skates to the flight controller. The roller skate power supply independently supplies power to the roller skate controller or shares the power supply with other parts of the aircraft system. The first ground separation sensor and the first human body attitude sensor adopt the prior art. For example, a pressure sensor is used to detect the pressure between the human foot and the electric roller skates or the pressure between the electric roller skates and the ground. When the detected pressure value is less than a set value, it means leaving the ground. An ultrasonic transmitting and receiving device fixed on the electric roller skates can be used to transmit ultrasonic waves to the ground. When the detected value of the returned ultrasonic waves is less than a set value, it means leaving the ground. The attitude sensor, such as a gyroscope, is used to detect the attitude of the human body. The gyroscope is arranged on the leg bracket 5 or the human body. When the human body or the leg bracket 5 tilts forward or backward, the gyroscope tilts forward or backward together and outputs the attitude signal of the human body.

For example, an angle sensor can be arranged at the connection end 9 of the leg bracket, and a potentiometer can be used as the angle sensor. The base 98 and the knob 99 of the potentiometer are arranged between the lower end of the leg bracket and the electric roller skates 7. When the rotation between the two occurs, the potentiometer outputs signals of different resistances corresponding to different angle information and outputs the forward or backward tilting attitude signals of the human body. One embodiment is shown in FIGS. 4, 6 and 7. In order to ensure that the connection end 9 of the leg bracket does not affect the mutual movement between the leg bracket 5 and the human-powered roller skates or electric roller skates, the connection end 9 of the leg bracket is arranged on the side of the human-powered roller skates, electric roller skates or electric balance car and the human body. The structure is as follows: an inner hole 91 with an internal thread is arranged on the side of the human-powered roller skates or electric roller skates and the human body. The left end of the first rotating shaft 95 is provided with an external thread to be matched with the internal thread of the inner hole. The left end of the first rotating shaft 95 passes through the first shaft sleeve 93 and the washer 92 in turn and is screwed into the inner hole 91. It can be understood that the rotating shaft 95 can also be fixed in the inner hole 91 by welding. A through hole 96 is arranged inside the first rotating shaft 95, a potentiometer is arranged in the through hole 96 at the right end of the first rotating shaft 95, and the potentiometer is provided with a signal line 97, a base 98 and a knob 99. The signal line 97 passes through the first rotating shaft 95 and enters the inside of the human-powered roller skates or electric roller skates and the human body. The base 98 is clamped inside the first rotating shaft 95, the upper end of the knob has a pin column, and when the base 98 is clamped into the first rotating shaft 95, the upper end of the knob 99 is inserted into a pin hole 94 arranged on the leg bracket 5 connected to the upper end of the first shaft sleeve 93. When the human body tilts forward or backward, the leg bracket 5 swings, and the first shaft sleeve 93 rotates around the first rotating shaft 95 due to the swing of the leg bracket 5, driving the pin column in the pin hole 94 and the knob 99 to rotate. The rotation of the knob 99 changes the resistance value inside the base 98, and the signal is transmitted through the signal line 97 to the roller skate controller of the driven roller skates or/and the flight controller. The connection end 9 of the leg bracket with this structure can be used for various pedal moving devices of the present application.

FIG. 4 is a schematic side view of the connection between the electric balance car and the leg bracket according to the present application. In the figure, the leg bracket 5 is connected to the electric balance car 8 through the connection end 9 of the leg bracket. The electric balance car 8 is provided with an electric balance wheel 81, and the other structures of the electric balance car are the prior art and are not shown and described here.

FIG. 6 is a schematic side view of the connection between the human-powered roller skates or electric roller skates and the leg bracket according to the present application. In the figure, the leg bracket 5 is connected to the human-powered roller skates or electric roller skates 7 through the connection end 9 of the leg bracket. When human-powered roller skates are used, a speed sensor 71 is arranged on the side of the pulley or the electric pulley to detect the running speed of the human-powered roller skates or electric roller skates 7, or when electric roller skates are used, the speed of the electric roller pulley of the electric roller skates is used to transmit signals to the roller skate controller of the electric roller skates or the flight controller. The other structures and shapes of the human-powered roller skates or electric roller skates 7 except those described in the present application are the prior art and are not shown and described here.

FIG. 2 is a schematic front view of the use of an aircraft system with human-powered roller skates or electric roller skates by a human body according to the present application; in conjunction with FIG. 1, it can be seen that a horizontal tail 10 and a vertical tail 11 are arranged on the leg bracket 5 and near the lower end position. The leg bracket is fixed to the human leg, so the movement of the human leg can drive the horizontal tail 10 and the vertical tail 11 to move, changing the direction and attitude of the horizontal tail 10 and the vertical tail 11.

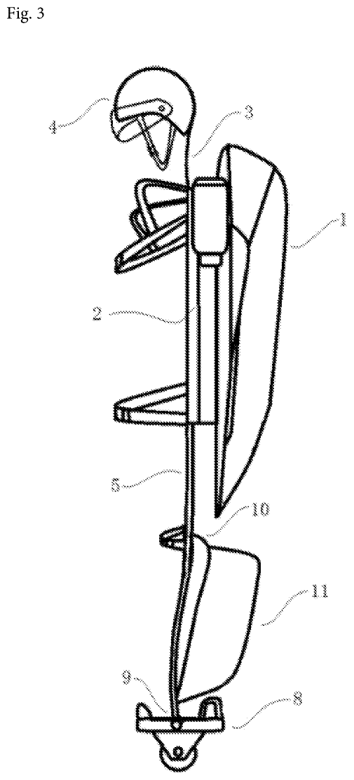

FIG. 3 is a schematic side view of an aircraft system with an electric balance car according to the present application; the difference between each part in this figure and FIG. 1 is that the electric balance car 8 is used as the pedal moving device. The electric balance car 8 has been widely used in the prior art as an entertainment and transportation tool, and its specific structure is not described here, and those skilled in the art can understand and implement it.

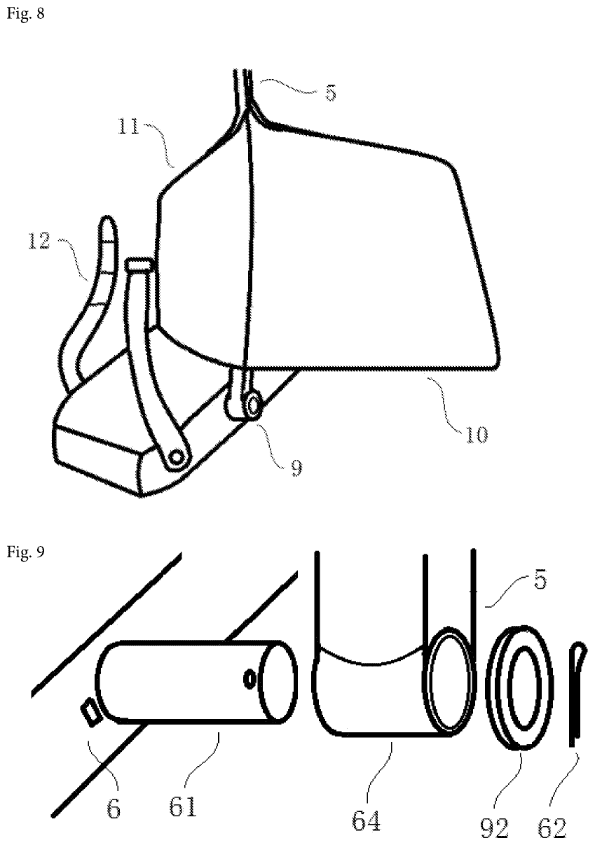

FIG. 8 is a schematic view of a connection structure of a horizontal tail and a vertical tail with the leg bracket according to the present application; in this figure, a horizontal tail 10 and a vertical tail 11 are arranged at a position of the leg bracket 5 near the connection end 9 of the leg bracket. The connection end 9 of the leg bracket is arranged on the outer side of the human leg and connected to the pedal moving device. The vertical tail 11 faces the rear side of the human foot, and the horizontal tail 10 faces the outer side of the human body. The foot fixing strap 12 is used for fixing the rear part of the human foot.

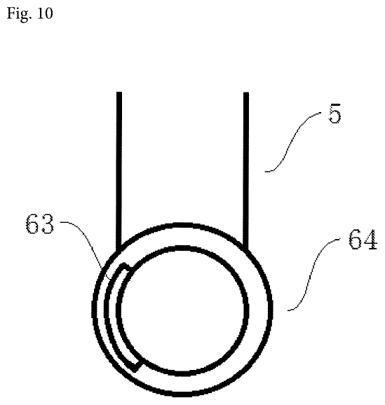

FIGS. 9 and 10 are a schematic view of another connection structure of the connection end of the leg bracket and a schematic partial view of another connection structure of the connection end of the leg bracket according to the present application; these figures show another connection structure of the connection end 9 of the leg bracket, which can adopt a magnetoelectric sensor, such as a linear Hall sensor. It includes a linear Hall device 6 arranged on the side of the pedal moving tool, a second rotating shaft 61 fixed on the side of the pedal moving device, a second shaft sleeve 64 connected to the lower end of the leg bracket 5, a washer 92, a pin 62 and a permanent magnet 63 arranged at one end of the second shaft sleeve 64 close to the pedal moving tool. The permanent magnet 63 has different magnetic forces along the rotating direction of the second shaft sleeve 64. The rotating shaft 61 passes through the second shaft sleeve 64 and the washer 92, and the pin 62 passes through the pin hole on the second rotating shaft 61 to limit the position of the second shaft sleeve 64. The second shaft sleeve 64 rotates due to the movement of the leg bracket 5. The linear Hall device 6 corresponds to the position of the permanent magnet 63 arranged on the second shaft sleeve 64, and the linear Hall device 6 outputs an electric signal due to different magnetic forces. The linear Hall device 6 is connected to the roller skate controller of the electric roller skates or/and the flight controller, and transmits the signal to the roller skate controller of the electric roller skates or/and the flight controller. The connection end 9 of the leg bracket with this structure can be used for various pedal moving devices of the present application.

In conjunction with the embodiments of FIGS. 1, 2 and 3, the aircraft body 1 is provided with left and right twin turbojet engines. It can be understood that various types of engines or electric motors can also be used as power drives, and more engines can also be used. Horizontal tails 10 are connected and arranged on the outer sides of the lower ends of the leg brackets relative to the human body, and vertical tails 11 are connected and arranged on the rear sides of the lower ends of the leg brackets relative to the human body. The movement of the human legs can drive the horizontal tails 10 and the vertical tails 11 to move, change the aerodynamic properties of the aircraft body, and change the movement direction of the aircraft body. Vertical tails are arranged at the lower ends of the two leg brackets to increase the ability of the human body to adjust the attitude of the aircraft body. Those skilled in the art can understand the basic principle and structure of the present application through FIGS. 1 and 2, and the structure and flight principle of the related aircraft are not described here. For example, a binding control handle is arranged on the human hand for the human body to control the aircraft body, or a control handle is arranged on the aircraft body, and the human body pulls, rotates or presses the handle with the hand to control the flight of the aircraft body. The related content already exists in the prior art of the aircraft, and the specific structure is not shown and described in the drawings of the present application, and those skilled in the art can understand and implement it according to the present application.

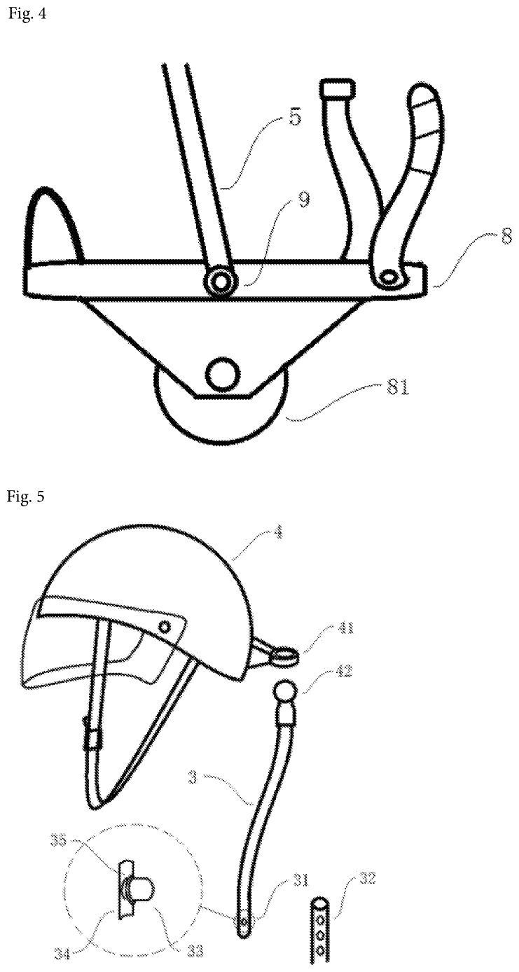

FIG. 5 is a schematic side view of a connection between the head bracket and a helmet according to the present application; the aircraft body 1 is also provided with a head bracket 3 upwards, and the head bracket 3 is directly or indirectly connected to the human head. The head bracket 3 has elasticity, or/and the connection position between the head bracket 3 and the head is a movable connection, so that the head can swing and rotate; a helmet first connection end 41 is arranged at the rear part of the helmet 4 in FIG. 5, and a helmet second connection end 42 is arranged at the upper end of the head bracket 3. The helmet first connection end 41 and the helmet second connection end 42 are movable connection devices matched with each other, such as the ball head and the ball socket shown in this figure, so that the helmet 4 can rotate in multiple directions. Other types of universal joints and other movable connection devices with the same function can also be used. The lower end of the head bracket 3 is a hollow tube, and an inner hole 31 of the head bracket is arranged on the side. A tubular structure with an outer hole 32 of the head bracket is arranged at the upper end of the fixing part 2 of the aircraft body 1. A positioning device is arranged in the inner hole 31 of the head bracket, and the positioning device includes a head bracket stop cap 33 connected to a stop cap bottom plate 34 through a stop cap spring 35. The head bracket stop cap 33 passes through the inner hole 31 of the head bracket and the outer hole 32 of the head bracket by means of the stop cap spring 35 to position the height of the head bracket 3. The height of the head bracket 3 is adjusted up and down by pressing the head bracket stop cap 33 to adapt to the different height needs of the human head and neck. The head bracket 3 is set not only to protect the head by means of the helmet 4, etc., but also to have a supporting force on the head because the head bracket 3 is connected between the aircraft body 1 and the helmet 4 or the head. The supporting force includes an axial force and a radial force from the aircraft body 1 to the head direction. When the human body and the aircraft body 1 stand or fly in the vertical direction, the human head is fixed to the helmet 4, and the axial upward supporting force of the head bracket 3 reduces the burden on the human head. When the human body and the aircraft body 1 fly horizontally, the radial supporting force of the head bracket 3 bears part of the weight of the human head and reduces the burden of the human head on the human neck. When the human body and the aircraft body 1 run obliquely, both the axial and radial supporting forces play a role in reducing the burden on the human body, avoiding excessive load on the human neck, and being beneficial to the control of the aircraft body 1 by the human body and long-time flight.

It can be understood that the size proportion of each component in the embodiment of the present application is not completely drawn according to the actual proportion, and those skilled in the art can understand and implement the related content, which does not limit the technical solution of the present application.

The shape of the aircraft body in the drawings of the embodiment of the present application is used to explain the use of the present application. Only the embodiments here are used to explain the present application. There are many shapes of the backpack aircraft, not only the shape in the drawings. The aircraft can also be provided with an electronic control system, and the wings can be provided with ailerons, flaps, etc. The wings can be an integrated wing or arranged on both sides of the aircraft body, which are all suitable for the present application. Therefore, it is obvious that the above embodiments are used for explanation rather than limitation of the present application.

### The Best Mode for Carrying Out The Invention

Type the description paragraph of the best mode for carrying out the invention here.

### Modes for Carrying out the Present Invention

Type the description paragraph of the best mode for carrying out the invention here.

### INDUSTRIAL APPLICABILITY

Type the description paragraph of industrial applicability here.

### Free-Form Content of the Sequence Listing

Type the description paragraph for the free-form content of the sequence listing here.

1. An aircraft control method, wherein the aircraft is fixedly connected to a human body, the aircraft is supported on the ground by the human body's feet, the human body's feet are provided with pedal moving devices capable of carrying the human body and the aircraft to move on the ground. The control method is characterized in that an operation-state information transmission device is provided between the aircraft and the pedal moving devices, and the control of the pedal moving devices is associated with the control of the aircraft through the information transmission device. The association method is that the aircraft controls its operation according to the operation state of the pedal moving devices, or the pedal moving devices control their operation according to the operation state of the aircraft.

2. The aircraft control method according to claim 1, wherein the association between the control of the pedal moving devices and the control of the aircraft is such that after the human body and the aircraft leave the ground, the pedal moving devices stop operating, the association between the control of the aircraft and the control of the pedal moving devices is canceled, and the aircraft is controlled to fly by the human body.

3. The aircraft control method according to claim 1, wherein the aircraft is provided with a flight power device and an attitude control device, the pedal moving devices are provided with pedal power devices. When the human body and the aircraft are on the ground, the output power of the pedal power devices of the pedal moving devices is in a positive proportional relationship with the output power of the flight power device of the aircraft, and/or the attitude control device of the aircraft adjusts the attitude according to the operation of the pedal moving devices.

4. An aircraft system, comprising an aircraft body and pedal moving devices, wherein the aircraft body is fixedly connected to a human body, the aircraft body is supported on the ground by the human body's feet, and the human body's feet are provided with pedal moving devices. The aircraft system is characterized in that an information transmission device is further provided between the pedal moving devices and the aircraft body, and the information transmission device is provided with a detection device for detecting the operation state of the pedal moving devices or/and the operation state of the aircraft body and transmitting data between the aircraft body and the pedal moving devices.

5. The aircraft system according to claim 4, wherein the aircraft body is provided with a flight power device, an attitude control device, an aircraft power supply, and a flight controller. The flight controller is powered by the aircraft power supply to control the operation of the flight power device and the attitude control device. The flight controller is connected to the information transmission device by wired or wireless means and controls the power output of the flight power device and/or the attitude control device according to the output data of the information transmission device.

6. The aircraft system according to claim 4, wherein the aircraft body is fixed to the human body's back through a fixing part, a shock-absorbing and buffering device is provided between the fixing part and the human body. The aircraft body is provided with leg brackets extending downward from the part where the fixing part of the aircraft body is fixed to the human body. The lower end of the leg brackets is connected to the human body's feet or the pedal moving devices. The leg brackets have elasticity, and the connection between the leg brackets and the human body's legs is such that the leg brackets have a tendency to bend along the bending direction of the human body's legs before being subjected to the pressure between the human body's feet and the aircraft body, and can bend in the bending direction of the human body's legs when subjected to the pressure between the human body's feet and the aircraft body. The leg brackets are provided with at least one of a horizontal tail and a vertical tail.

7. The aircraft system according to claim 4, wherein the aircraft body is further provided with a head bracket upwards, the head bracket is directly or indirectly connected to the human body's head, and the head bracket has elasticity, or/and the connection position between the head bracket and the head is a movable connection, so that the head can swing and rotate.

8. The aircraft system according to claim 4, wherein the pedal moving devices are human-powered roller skates that run by human pedaling. The human-powered roller skates are respectively fixed under the human body's left and right feet and can run forward alternately. The human-powered roller skates are provided with pulleys and a speed sensor for detecting the running speed and/or acceleration of the pulleys. The speed sensor is connected to the flight controller by a cable or a wireless transceiver between the aircraft body and the human-powered roller skates to transmit the speed information of the human-powered roller skates to the flight controller. Or the speed sensor detects the speed of the human-powered roller skates relative to the ground and is connected to the flight controller by a cable or a wireless transceiver between the aircraft body and the human-powered roller skates to transmit the speed information of the human-powered roller skates to the flight controller. When the human-powered roller skates leave the ground, the speed sensor detects that the speed value is less than a set value or zero and transmits information to the flight controller of the aircraft body to switch the control of the aircraft body.

9. The aircraft system according to claim 4, wherein the pedal moving devices are electric roller skates provided with electric roller pulleys, a roller skate controller, and a roller skate power supply. The electric roller skates are respectively fixed under the human body's left and right feet and can run forward alternately. The electric roller pulleys are of wheel type or track type, and the roller skate controller controls the operation of the electric roller pulleys by means of the roller skate power supply. The electric roller skates are further provided with a first ground separation sensor and a first human body attitude sensor connected to the roller skate controller. The first ground separation sensor is used for detecting whether the electric roller skates are in a ground separation state or a ground connection state, and the first human body attitude sensor is used for detecting the forward or backward tilting attitude of the human body. The roller skate controller controls the electric roller pulleys to operate when both feet are on the ground according to the information of the first ground separation sensor, controls the electric roller pulleys on the ground and the ground separation to operate at the same speed when one foot is on the ground, and controls the electric roller pulleys to stop operating when both feet are off the ground. The roller skate controller controls the electric roller skates to accelerate when the human body tilts forward and decelerate when the human body tilts backward according to the information of the first human body attitude sensor. At least one of the first ground separation sensor, the first human body attitude sensor, and the roller skate controller is connected to the flight controller to transmit the signals of the electric roller skates to the flight controller. The roller skate power supply independently supplies power to the roller skate controller or shares the power supply with the aircraft body.

10. The aircraft system according to claim 4, wherein the pedal moving devices are electric balance cars respectively arranged under the human body's left and right feet and capable of running forward alternately. The electric balance cars are further provided with electric balance wheels, a balance controller, and a balance car power supply. The balance controller controls the operation of the electric balance wheels and the balance of the electric balance cars by means of the balance car power supply. The electric balance cars are provided with a second ground separation sensor and a second human body attitude sensor connected to the balance controller. The second ground separation sensor is used for detecting whether the electric balance cars are in a ground separation state or a ground connection state, and the second human body attitude sensor is used for detecting the forward or backward tilting attitude of the human body. The balance controller controls the electric balance wheels to operate when both feet are on the ground according to the information of the second ground separation sensor, controls the electric balance wheels on the ground and the ground separation to operate at the same speed when one foot is on the ground, and controls the electric balance wheels to stop operating when both feet are off the ground. The balance controller controls the electric balance cars to accelerate when the human body tilts forward and decelerate or move backward when the human body tilts backward to maintain the balance of the human body according to the information of the second human body attitude sensor. At least one of the second ground separation sensor, the second human body attitude sensor, and the balance controller is connected to the flight controller to transmit the signals of the electric balance cars to the flight controller. The balance car power supply independently supplies power to the balance controller or shares the power supply with the aircraft body.
